(19) United States
(12) Patent Application Publication
(10) Pub. No.: US 2009/0137705 A1
(43) Pub. Date: May 28, 2009

(54) HOT-MELT BINDER BASED ON ASPHALT OR BITUMEN AT LOWER PRODUCTION TEMPERATURE COMPRISING A TRIGLYCERIDE OF SATURATED FATTY ACIDS

(75) Inventors: Stephane FAUCON DUMONT, Martignas (FR); Frederic Delfosse, Pessac (FR); Thomas Gianetti, Bordeaux (FR)

Correspondence Address: FOLEY AND LARDNER LLP;SUITE 500, 3000 K STREET NW, WASHINGTON, DC, 20007, US

(73) Assignee: EUROVIA

(21) Appl. No.: 12/275,029

(22) Filed: Nov. 20, 2008

(30) Foreign Application Priority Data
Nov. 20, 2007 (FR) 0759166

(51) Int. Cl. C09D 109/06; C09D 7/12

(52) U.S. Cl. 524/71; 106/269; 106/246; 106/229

(57) ABSTRACT

The present invention relates to a hot-melt binder based on asphalt or bitumen, comprising at least one additive for lowering the production temperature of the asphalt product relative to that of the base product, said additive being a triglyceride of saturated fatty acids.

The present invention likewise relates to processes for preparing an asphalt or bituminous product coated material, in which the mixing temperature is lowered.

The present invention finally relates to an asphalt product or coated bituminous material comprising a hot-melt binder according to the invention.

The present invention relates to the formulation of a hot-melt binder, based on natural asphalt or bitumen, optionally added with a polymer, which comprises at least one additive intended to lower the production and processing temperature of this binder in roadway applications, while retaining the properties required for its applications or even to improve them.

Bitumen is a viscoelastic product which requires heating to be handled, emulsionned or added with mixtures with fluxing agents of petroleum, petrochemical, carbochemical or even plant origin to reduce its viscosity.

In all such cases, the person skilled in the art will seek to allow the bitumen to retrieve its properties while reducing to a maximum the environmental constraints.

Specific fields of application include asphalt or bituminous products which could thus be made and processed at significantly lower temperatures than those necessary when said products contain a binder in which the additive according to the invention is absent, as well as surface coatings.

In the present invention <<asphalt product>> is understood to mean a hot-melt flowable mixture of hot-melt binder of bituminous type together with mineral filler. An asphalt product does not need to be roller compacted when implemented. It should thus be easily cast and spread. Examples of asphalt products include in particular asphalts, sealants, pavement seals and heat sealing materials.

In the present invention <<bituminous product>> is understood to mean a hot-melt flowable mixture of hot-melt binder of bituminous type together with granulates and optionally with a mineral filler. A bituminous product is then conventionally roller compacted.

Mineral fillers consist of elements of less than 0.063 mm and optionally aggregates originating from recycled materials, sand with grain sizes between 0.063 mm and 2 mm and optionally grit, containing grains of a size greater than 2 mm, and optionally alumino-silicates. The aluminosilicates are inorganic compounds based on aluminium and sodium silicates or other metal such as potassium or calcium silicates. Aluminosilicates reduce the viscosity of the hot-melt binder and are in form of a powder and/or granulates.

The term <<granulate(s)>> refers to mineral and/or synthetic granulates, especially coated material aggregates, which are conventionally added to bituminous binders for making mixtures of materials for road construction.

The preparation of an asphalt product (such as melted asphalt) or of a bituminous product comprises mixing the binder and fillers or granulates at a temperature, known as the production temperature, then casting this mixture at a processing temperature, followed by cooling. High production and processing temperatures represent major energy consumption and simultaneously environmental pollution due to undesirable gas effluents. High ranges of production and processing temperature cause, for certain types of bitumen, a breakdown which releases blue smokes.

The purpose is therefore to lower the production and processing temperature of asphalt or bituminous products.

Solutions for lowering the production temperature of asphalt products have already been proposed. Patent application FR 2 855 523 describes adding a hydrocarbon wax with a melting point greater than 85° C. (molecular weight between 500 and 6000 g/mol) and a second additive which is a fatty acid ester wax, this wax being of synthetic, vegetable, or plant fossil origin and having a melting point less than 85° C. (melting points measured according to ASTM D3945 and D3418 standards). Examples of fatty acid esters are esters of montanic acid (or esters of octasonoic acid), an acid of the formula C₂₈H₅₆O₂, or esters of lignoceric acid (or esters of tetracosanoic acid), an acid of the formula C₂₄H₄₈O₂. However, the length of the hydrocarbon chain derived from the alcohol is not specified.

U.S. Pat. No. 6,588,974 describes the use of synthetic waxes of Fischer Tropsch type for reducing the processing temperature, facilitating compacting and improving the strain strength under load of the coating.

The aim of the present invention is to propose another type of additive which can be used in the binder for lowering the production and processing temperature of asphalt and bituminous products. Of course, adding this additive should not be prejudicial to the properties and performance of the resulting asphalt or bituminous products.

Within the scope of the invention, the additive is at least a triglyceride of fatty acids, said fatty acid being selected from the group consisting of saturated fatty acids, comprising from 12 to 30 carbon atoms, preferably from 12 to 20 carbon atoms, and optionally substituted by at least one hydroxyl function or by a C₁-C₄ alkyl radical. A saturated fatty acid contains no unsaturations (double or triple carbon-carbon bonds).

Within the scope of the present invention, the term <<fatty acid triglyceride >> is understood to mean a glycerol derivative with all three hydroxyl functions substituted by a fatty acid such as defined above. Small amounts (less than 5% by weight relative to the mass quantity of triglycerides involved) of diglycerides, monoglycerides and even free fatty acids can be included in this definition.

Within the scope of the present invention, the term <<substituted by at least one hydroxyl function or by a C₁-C₄ alkyl radical >> are understood to mean a fatty acid with at least one carbon atom substituted by a hydroxyl function (advantageously by a single hydroxyl function) and/or by an alkyl radical containing from 1 to 4 carbon atoms (examples are methyl, ethyl, propyl, butyl, t-butyl, isopropyl radicals). The fatty acid, if it is substituted, is advantageously only substituted by hydroxyl group(s), in particular by a single hydroxyl group.

The triglyceride comprises from 39 to 93 carbon atoms, advantageously 39 to 63 carbon atoms, more advantageously 51 to 63 carbon atoms. Mixed triglycerides (the molecules of fatty acids constituting the triester are different) or homogeneous triglycerides (the molecules of fatty acids constituting the triester are identical) are possible, with a preference for homogeneous triglycerides. According to a preferred embodiment of the invention, the molecules of fatty acids comprise from 12 to 30 carbon atoms, advantageously 12 to 20 carbon atoms, more advantageously 16 to 20 carbon atoms.

The use of diglycerides comprising the same number of carbon atoms (39 to 93) in which the molecules of fatty acids would have longer chains is also possible. However, such diglycerides can only be obtained by synthesis. Triglycerides of natural origin are preferred.

Preferred saturated fatty acid molecules include for example: 12-hydroxy-octadecanoic acid (C18, also known as 12-hydroxystearic acid), hexadecanoic acid (C16, also known as palmitic acid), octadecanoic acid (C18, also known as stearic acid), 9,10-dihydroxy-octadecanoic acid (C18, also known as dihydroxystearic acid), icosanoic acid (C20, also known as arachidic acid), and nonadecanoic acid (C19).

According to an advantageous embodiment of the invention, the additive comprises at least one triglyceride comprising one molecule of fatty acid which is 12-hydroxy-octadecanoic acid.

The additive content will be advantageously between 1 and 20% by mass relative to the total mass of binder. In particular, in an asphalt product, the additive content will be advantageously between 6 and 12% by mass relative to the total binder mass. When the binder is intended for preparation of bituminous coated material, the additive content will be advantageously between 1 and 6% by mass relative to the total mass of binder.

The triglyceride can be obtained by synthesis, as known to the skilled person, or is advantageously of natural origin. For superior plants and animals, the most common fatty acids, which triglycerides derive from, comprise from 14 to 20 carbon atoms, with those having 16 or 18 carbon atoms being highly predominant. Fatty acids with a number of carbons greater than 24 are essentially components of protective waxes made by plants, bacteria and insects.

In particular, according to an advantageous embodiment of the invention, the source of triglycerides is a hydrogenated vegetable oil.

Vegetable oil is understood to mean raw or refined oils, obtained by trituration of plant seeds, stones or fruits, in particular oleaginous plants, including, but not limited to, flax, rapeseed, sunflower, soya, olive, palm, castor, wood, corn, squash, grape-seed, jojoba, sesame, walnut, hazelnut, almond, shea butter, macadamia, cotton, lucerne, rye, safflower, peanut, coco and argan oils.

The vegetable oil is hydrogenated, that is, it has undergone a hydrogenation process in which any unsaturations (double bonds) in natural fatty acids are hydrogenated, in order to obtain essentially saturated fatty acids.

Hydrogenated vegetable oil advantageously has an iodine value according to the ISO 3961 standard of less than 50 g of I₂/100 g, advantageously less than 10 g of I₂/100 g, more advantageously less than 5 g of I₂/100 g, even more advantageously less than 3.5 g of I₂/100 g. The iodine value of a lipid is the mass of diiodine (I₂) (expressed in g) that can be fixed to the unsaturations (most often double bonds) of fatty acids of 100 g of fat.

Hydrogenated vegetable oil advantageously has an acid value according to the NF T 60-204 standard of less than 10 mg KOH/g, more advantageously an acid value of less than 5 mg KOH/g, even more advantageously an acid value of less than 2 mg KOH/g. The acid value is the mass of potassium hydroxide (expressed in mg) necessary to neutralize free fatty acids contained in one gram of fat.

Hydrogenated vegetable oil advantageously has a saponification value between 150 and 200 mg KOH/g, more advantageously a saponification value between 170 and 190 mg KOH/g. The saponification value refers to the mass of potassium hydroxide in mg necessary to neutralize free fatty acids and to saponify combined fatty acids in one gram of fat.

Hydrogenated vegetable oil can comprise hydroxyl functionalities, and thus advantageously has a hydroxyl value of between 140 and 180 mg KOH/g, more advantageously a hydroxyl value between 150 and 170 mg KOH/g. The hydroxyl value is the number of milligrams of potassium hydroxide which would be necessary to neutralize acetic acid which acetylates one gram of product. In practical terms, acetic anhydride is used and the calculation of the hydroxyl value takes into account the acid value.

The content of unsaponifiables in the oil is advantageously less than 10%, more advantageously less than 5%, even more advantageously less than 1%, the percentage being based on the total weight of the oil.

The hydrogenated vegetable oil content will be preferably between 1 and 20% by mass relative to the total mass of binder. In particular, in an asphalt product, the hydrogenated vegetable oil content will be preferably between 6 and 12% by mass relative to the total mass of binder. When the binder is intended for preparation of bituminous coated materials, the hydrogenated vegetable oil content will preferably be between 1 and 6% by mass relative to the total mass of binder.

To fluidify the binder during its processing, the additive has a melting temperature greater than 60° C., preferably greater than 80° C. The additive preferably has a melting temperature less than 140° C., more preferably less than 120° C.

It is likewise necessary for the asphalt or bituminous product to retain other characteristics of a classic asphalt or bituminous product, in particular the required values of indentation and shrinkage.

The indentation values are measured following the standard NF EN 12697-21. Penetration of a punch is measured in tens of millimeters in the asphalt product, for a given period and temperature. The indentation values characterize the hardness of the cast asphalt. According to the Specifications of the French Asphalt Office, the asphalt or bituminous product should have an indentation value, measured at 40° C., of between 15 and 35-45 tens of millimeters, depending on the application (e.g. asphalt for pavement or asphalt for roads). Asphalts for sealing applications should have indentation values conforming to the specifications of the NF EN 12970 standard.

Also, the asphalt or bituminous product should likewise not have very high free shrinkage values. Free shrinkage (measured in millimeters) corresponds to a decrease in volume accompanying the curing and hardening of the asphalt or bituminous product and induced by cooling of the asphalt or bituminous product. Substantial free shrinkage results in disorders prejudicial to the perennity of the asphalt or bituminous product. Excessive shrinkage could degrade the mechanical characteristics and be harmful to the sealing properties of the asphalt or bituminous product.

The aim of the invention therefore is to provide a binder which can be made and processed at a lower temperature, while retaining efficient properties for the resulting asphalt or bituminous product.

The bitumen can be natural bitumen, bitumen of plant origin or bitumen of petroleum origin, optionally modified by adding polymers. The asphalt and bituminous products can contain High contents (ranging from 0% to 100% by weight, preferably from 20% to 50% by weight, relative to the total weight) of recycled products (aggregates of asphalt product, aggregates of coated material).

The additive according to the invention can be used alone or mixed with other additives.

Another additive which can be added is a flux which lowers the viscosity of the hot-melt binder (solvent properties) and can thus improve low-temperature properties (cooling of processing temperatures at temperatures of use). These fluxes, likewise known as fluxing oils, can be based on fatty animal and/or vegetable substances (oils and fats), thus preventing the release of volatile organic compounds. Any flux of natural origin, optionally modified by chemical reaction (other than hydrogenation) could preferably be used. The fluxing oil can be a vegetable oil, a distillation residue of a vegetable oil, a derivative thereof such as its fatty acid moity, a mixture of fatty acids, a transesterification product (with a C₁-C₆ alkanol) such as a methyl ester of the vegetable oil or an alkyde resin derivative of the vegetable oil. The vegetable oil comprises unsaturated fatty chains. Also, the vegetable oil is preferably subjected to an isomerisation treatment in order to increase the number of conjugated C═C double bonds, resulting in an increase in the drying power. The vegetable oil can likewise be subjected to a treatment for chemically modifying the fatty chains by introduction of chemical functions (likely to react with chemical functions present in the binder and/or with chemical functions of other flux molecules). This can be done by functionalizing the vegetable oil in order to introduce the following functional groups: carboxylic acid, epoxide, peroxide, aldehyde, ether, ester, alcohol and ketone groups (by oxidation, for example).

Vegetable oil is understood as meaning raw or refined oils, obtained by trituration of plant seeds, stones or fruits, in particular oleaginous plants, such as, non-limiting, flax, rapeseed, sunflower, soya, olive, palm, castor, wood, corn, squash, grape-seed, jojoba, sesame, walnut, hazelnut, almond, shea butter, macadamia, cotton, lucerne, rye, safflower, peanut, coco and argan oils, derivatives, and mixtures thereof. These oils could be used as such or with a drying agent or following chemical functionalization—such as described previously—in ranges of between 0 and 1 pph (part per hundred by weight) and preferably between 0 and 0.6 pph, relative to the weight of the asphalt or bituminous product.

A drying agent is understood as being any compound capable of accelerating the drying reaction of the plasticizer. For example this can be metal salts, especially organic salts of cobalt, manganese and zirconium.

Examples of other additives include likewise waxes of animal or plant origin or hydrocarbons, in particular long-chain hydrocarbon waxes (more than 30 carbon atoms). This additive also lowers the production and processing temperature of the hot-melt binder.

Hydrocarbon wax can be of a low to high molecular weight. A high molecular weight is for example a molecular weight between 10,000 and 20,000 g/mol, especially a molecular weight between 12,000 and 15,000 g/mol. A low molecular weight is a molecular weight greater than 400 g/mol and less than 6 000 g/mol, in the case of a hydrocarbon wax based on polyethylene or likewise of a hydrocarbon wax obtained by Fischer Tropsch synthesis (such a Fischer Tropsch wax sold under the brand name Sasobit® by Sasol).

According to an advantageous embodiment of the invention, a wax having a (defined) melting point greater than 80° C., more preferably between 95° C. and 130° C. is used in combination.

The hot-melt binder, according to this embodiment, contains preferably 1 to 20% by mass of said wax relative to the total mass of the binder.

As a further additive, a fatty acid derivative selected from the group consisting of fatty acid diesters, fatty acid ethers, amide waxes, diamide waxes and mixtures thereof can likewise be added.

This other additive lowers the production and processing temperature of the asphalt or bituminous product still further, while ensuring retention of the good mechanical properties of the asphalt or bituminous product, in particular indentation values, free shrinkage and Young's modulus.

Diester is a product resulting from the reaction of two alcohols and a dicarboxylic acid. The fatty acid diester is preferably a diester of vegetable, synthetic, animal or plant fossil origin with a number of carbon atoms between 20 and 56 and preferably between 26 and 48. The fatty acid diester preferably has a melting point greater than or equal to 70° C. The diesters resulting from the reaction of two fatty alcohols and fumaric acid are preferred. Said fatty alcohols preferably comprise 18 to 22 carbon atoms. An example of a diester of fumaric acid includes behenyl fumarate.

An ether is known to be a compound in which an oxygen atom is bound by a single bond to two organic groups which can be the same or different. The fatty acid ether is preferably a fatty acid ether of vegetable, synthetic, animal or plant fossil origin having a number of carbon atoms between 20 and 50, preferably between 30 and 40. The fatty acid ether preferably has a melting point greater than or equal to 60° C. An example of a preferred ether fatty acid includes distearyl ether (C₁₈H₃₇OC₁₈H₃₇).

An amide wax is a product resulting from the reaction of a fatty acid (12 to 30 carbon atoms, preferably 16 to 20 carbon atoms) with a long-chain amine (12 to 30 carbon atoms, preferably 16 to 20 carbon atoms). The amide wax preferably has a melting point greater than or equal to 80° C. (up to 115° C.).

A diamide wax is a product coming from the reaction of two amines and one dicarboxylic acid. At least one of the amines is a long-chain amine (12 to 30 carbon atoms, preferably 16 to 20 carbon atoms), preferably both amines are long-chain amines. The dicarboxylic acid is preferably fumaric acid. The diamide wax preferably has a melting point greater than or equal to 80° C.

A natural resin, optionally modified, of plant origin, can likewise be added as a further additive.

The resin improves handling of the asphalt or bituminous product by enhancing its richness modulus. Also, the resin provides for good dimensional stability at service temperatures. The asphalt or bituminous product thus has good mechanical strength under static or dynamic load.

Most natural or modified natural resins of plant origin do not have a well-defined melting point, but does have a softening range. These are non-crystalline compounds. The resin preferably has a softening point of less than 130° C., even more preferably less than 120° C. and more preferably greater than 65° C.

The hot-melt binder, according to the first embodiment, preferably contains 1 to 20% by mass of said resin of plant origin relative to the total mass of the binder.

The resin of plant origin preferably contains abietic acid or derivatives thereof, especially hydroabietic acid, neoabietic acid, palustric acid, pimaric acid, levopimaric acid, isopimaric acid.

The resin of plant origin is preferably selected from the group consisting of natural or modified natural rosins, rosin esters, rosin soaps, terpenes, tall oil, dammar, accroid resins. The resin of plant origin is more particularly a rosin-based resin, for example glycerol ester of maleic rosin.

The hot-melt binder according to the invention can likewise comprise other additives for lowering the production temperature, the processing temperature and/or for improving the mixing and handling conditions. In particular, the hot-melt binder can comprise a natural and/or synthetic zeolite, or its initial amorphous synthesis phase.

Under the action of heat (i.e. at a temperature greater than 110° C.) the zeolite is capable of releasing water molecules from between the layers or the voids in its crystalline network. The release of this physically trapped water, known as <<zeolitic water >>, lowers the production and processing temperature and above all improves the mixing and handling conditions of the mixture. Zeolite can be added in pulverulent form (diameter of around 10 μm) or in the form of granules, said granules comprising fine particles of zeolite aggregated by means of a binder or an adhesive (derivative of cellulose, in particular carboxymethyl cellulose), said fine particles having an average diameter between 2 μm and 4 μm. It is preferred to add zeolite in the form of granules, which allows, apart from easier handling (better handling, restricted forming of dust, better fluidity, no cooking), improved and faster distribution of the zeolite during production of the asphalt product.

The zeolite used is preferably a fibrous zeolite, a lamellar zeolite and/or a cubic zeolite. The zeolite used can belong to the group of saujasites, chabasites, phillipstes, clilioptilolites, and/or paulingites.

By comparison to zeolites of natural sources, artificial zeolites often have the advantage of having homogeneity and consistant quality, which is advantageous especially for the required fineness. Therefore, the zeolite used is preferably synthetic zeolite of the type A, P, X and/or Y. A granule of zeolite of type A, especially of the empirical formula Na₁₂(AlO₂)₁₂(SiO₂)₁₂, 27H₂O where Na₂O is 18%, Al₂O₃ 28%, SiO₂ 33% and H₂O 21% will preferably be used.

The binder can preferably comprise 0.1 to 2 pph of zeolite.

The zeolite can be added during preparation of the binder prior to its transport (in production units which mix, heat, plasticize all the base elements) in carrier trucks, mixers or at the last moment, before the casting of the asphalt or bituminous product, once the trucks have arrived on site.

The hot-melt binder can also comprise an elastomer or a plastomer, especially a copolymer of styrene-butadiene-styrene, styrene-butadiene, or styrene-isoprene-styrene or especially a copolymer of ethylene.

The hot-melt binder can likewise comprise surfactants, lime, aluminosilicates and other additives conventionally added to asphalt products and the bituminous coated materials.

Another object of the invention is also a process for preparing a hot-melt flowable asphalt product wherein a hot-melt binder, said hot-melt binder being optionally further added with polymers (especially elastomers and/or plastomers), is mixed with mineral and/or synthetic fillers, asphalt aggregates, and at least the additive according to the invention (triglyceride of saturated fatty acids, in particular hydrogenated vegetable oil) and optionally other additives (such as especially a flux, a wax, a fatty acid derivative—diester, ether, amide, diamide—a resin, a zeolite and other classic additives), the process being characterized by its mixing temperature which is between 140° C. and 180° C.

It seems that the order of addition of the constituents has no influence on the properties of the asphalt product obtained. The different additives can be added in any order, or even simultaneously.

The asphalt products are conventionally made at temperatures in the range of from 200° C. to 270° C. By adding the additive according to the invention (which is able to lower the production temperature of the asphalt product relative to that of the base product), the asphalt product can be made at a lower temperature than usual, that is at a temperature between 140° C. and 180° C. Also, it can likewise be cast, that is, processed at this lower-than-usual temperature.

Another object of the invention is a hot-melt flowable asphalt product containing a hot-melt binder according to the invention and fillers, mineral and/or synthetic and asphalt aggregates. The asphalt product can also comprise additives such as surfactants, lime or aluminosilicates. The asphalt product can be obtained by the processes according to the invention, described above.

The invention also provides
a sealant, which comprises a hot-melt binder according to the invention (comprising the additive according to the invention) and mineral fillers of 0/6 mm and optionally one or more polymer(s);
a pavement seal, which comprises a hot-melt binder according to the invention (comprising the additive according to the invention) and mineral fillers of 0/6 mm and optionally one or more polymer(s);
a heat sealing material, which comprises a hot-melt binder according to the invention (comprising the additive according to the invention) and mineral fillers of 0/6 mm and optionally one or more polymer(s).

For those materials (sealant, pavement seal and heat sealing material), the mass percentage hot-melt binder/mineral fillers is preferably between 20/80 and 80/20. These materials can be obtained by processes according to the invention, as described above.

Another object of the invention is a process for preparing bituminous coated materials, wherein a hot-melt binder is added, said hot-melt binder being optionally added with polymers (especially elastomers and/or plastomers), with mineral and/or synthetic fillers, coated material aggregates, and at least the additive according to the invention (triglyceride of saturated fatty acids, in particular hydrogenated vegetable oil) and optionally the other additives (such as especially a flux, a wax, a fatty acid derivative—diester, ether, amide, diamide—a resin, a zeolite and other classic additives), the process being characterized by its mixing temperature which is between 90° C. and 130° C.

It seems that the constituents can be added in any desired order. The different additives can be added in any order, or even simultaneously.

The bituminous coated materials are conventionally made at temperatures varying from 150° C. to 200° C. By adding at least the additive according to the invention (triglyceride of saturated fatty acids, in particular hydrogenated vegetable oil), capable of lowering the production temperature, the bituminous coated material can be made and used at a lower temperature than usual, it means at a temperature between 90° C. and 130° C.

Another object of the invention is bituminous coated materials containing a hot-melt binder according to the invention, asphalt aggregates (or other granulates) and mineral and/or synthetic fillers. The bituminous coated materials can also comprise additives such as surfactants (cationic, anionic, amphoteric or non ionic surfactants), lime or aluminosilicates or other additives conventionally added to bituminous concrete. The bituminous coated materials can be obtained by the process according to the invention, described above.

Another object of the invention is the use of an asphalt product according to the invention or bituminous coated material according to the invention for making road surfaces, pavements or other urban facilities, sealing coatings for structures and buildings, sealants, pavement seals, heat sealing materials (as per NF EN 14188-1 standard).

The asphalt product can likewise be used for making bituminous coated materials.

The invention makes it possible to provide a binder which produces asphalt or bituminous products at sufficiently low production and processing temperatures to substantially eliminate smoke emissions, while retaining the mechanical properties of the resulting asphalt or bituminous products.

The following examples illustrate the present invention but are not limiting. The indentation, free shrinkage and breaking stress values have been measured according to the following procedures. The percentages indicated are weight percentages relative to the total weight of the asphalt product.

### Indentation:

Indentation tests are conducted according to the NF EN 12697-21 standard. This standard describes a method for measuring the indentation of cast asphalt when subjected to penetration of a cylindrical standardized punch with a flat circular fitting, at given values of temperature and coad and for a fixed application time.

The punch has a diameter of:
(25.2±0.1) mm for a surface of 500 mm²
(11.3±0.1) mm for a surface of 100 mm²
(6.35±0.1) mm for a surface of 31.7 mm²

The samples are cast into moulds at the production temperature of the asphalt product and left to cool in open air.

The samples are then immersed for at least 60 min in the thermostatic bath regulated to the test temperature. Then, the test piece is placed under the measuring instrument. Several tests are carried out on the same test piece; the punch is not placed less than 30 mm from the edge and less than 30 mm from the placement of the preceding test.

The test conditions are as in the following Table 1:

TABLE 1
test conditions

| | Type | | | |
|---|---|---|---|---|
| Parameter | Test W | Test A | Test B | Test C |
| Temperature | 25° C., | 25° C. | 40° C. | 25° C., |
| | 35° C., | | | 35° C., |
| | 45° C. | | | 40° C. |
| Surface of | 31.7 mm² | 500 mm² | 500 mm² | 100 mm² |
| the punch | | | | |
| Applied load | (311 ± 2) N | (515 ± 3) N | (515 ± 3) N | (515 ± 3) N |
| Application | 70 sec | 6 min | 31 min | 31 min |
| duration of | | | | |
| the load | | | | |
| Measured | 10 sec and | 1 min and | 1 min and | 1 min and |
| between | 70 sec | 6 min | 31 min | 31 min |

The tests are repeated 5 times on the same test piece for test W and 3 times for tests A, B and C.

### Free Shrinkage:

The test consists of casting the hot asphalt into a rectangular invar mould and, after levelling, subjecting this sample to thermal stresses. The dimensional variations of the test piece relative to the initial dimensions are measured using a calliper.

The average of the variation in length added to that of the width expressed in mm is defined as the free shrinkage value of the asphalt after cooling.

Measurements are made after 24H at 20° C. then 24H at −20° C. and to finish after 4H at room temperature.

### Hydrogenated Oil

The hydrogenated oil used in the following examples is hydrogenated castor oil having the following characteristics:

| | |
|---|---|
| Melting point (° C.) | 84-89 |
| Acid value (mg KOH/g) | ≦2 |
| Saponification value (mg KOH/g) | 174/186 |
| Iodine value (gI₂/100 g) | ≦3.5 |
| Hydroxyl value (mg KOH/g) | 155-165 |
| Acetyl index | ≧139 |
| Unsaponifiable (%) | ≦1.0 |

This hydrogenated castor oil has, after saponification, approximately the following fatty acid composition (percentages expressed by weight relative to the total weight):

87% of 12-hydroxy-octadecanoic acid

11% of stearic acid

2% of palmitic acid

traces of (9,10)-dihydroxystearic acid

### EXAMPLE 1

### Asphalt Product AG 3 0/6 Based on Hydrogenated Oil

An asphalt product AG3 is a cast asphalt product generally intended for sealing coatings for engineering structures. In particular, this coating is placed in the second sealing layer on bridges. It is called grit asphalt for bridge sealing. The composition and the properties of the asphalts produced are given in the following Table 2:

TABLE 2

| | | Asphalt product |
|---|---|---|
| | Classic asphalt | according to the |
| Composition | product | invention |
| Granular | 30% filler, 33% sand, 37% 4/6 | |
| formula | | |
| Bitumen 35/50 | 8.40 pph | 8.60 pph |
| Hydrogenated | — | 0.8 pph |
| castor oil | | |
| Production | 230° C. | 170° C. |
| temperature | | |
| Indentation | 21 | 22 |
| (1/10 mm) | | |
| Type B | | |
| (specifications *: | | |
| 15 to 40) | | |
| Handling (W) | 7 | 7 |

* issue 10 of the administrative and technical specification common to cast asphalts (1999)

*issue 10 of the administrative and technical specification common to cast asphalts (1999)

These results show that the asphalt product formula according to the invention can be processed at a much lower temperature, i.e. 60° C., than that necessary for processing the reference formula. This drop in temperature is not detrimental to the physical properties of the asphalt product, which has at least equivalent properties of indentation and handling.

### EXAMPLE 2

### Asphalt Product AT (Pavement) Based on Hydrogenated Castor Oil

An asphalt product AT is intended particularly for pavements surfaces with pedestrian traffic. The compositions and properties of the resulting asphalt products are given in the following Table 3:

TABLE 3

| | | Asphalt product |
|---|---|---|
| | Classic asphalt | according to |
| Composition | product | the invention |
| Granular formula | 27 filler, 43.5% sand, 29.5% 4/6 | |
| Bitumen 35/50 | 8.6 pph | 8.3 pph |
| Hydrogenated castor | — | 0.8 pph |
| oil | | |
| Production | 230° C. | 160° C. |
| temperature | | |
| Indentation at 40° C. | 50 | 30 |
| (1/10 mm) | | |
| Type B | | |
| (specifications *: | | |
| 20 to 50) | | |
| Indentation at 50° C. | 178 | 93 |
| (1/10 mm) | | |
| Type B | | |
| Handling (W) | 7 | 7 |

* issue 10 of the administrative and technical specification common to cast asphalts (1999)

*issue 10 of the administrative and technical specification common to cast asphalts (1999)

The asphalt product according to the invention can be processed at a temperature 70° C. lower than that necessary for processing the reference formula. Also, the asphalt product according to the invention has better indentation characteristics at 50° C. Lower thermal sensitivity of the asphalt product according to the invention can be noted. Between 40 and 50° C. there is a variation in indentation of 63 1/10 mm as opposed to 128 1/10 mm for the reference formula.

### EXAMPLE 3

### Asphalt Product AC 1 0/6 Based on Hydrogenated Oil

An asphalt product AC 1 is intended particularly for light road surfaces. To evaluate free shrinkage performance of asphalt based on hydrogenated oil we tested 2 formulas (with or without additive) having the close indentation characteristics at 40° C. The compositions and the properties of the resulting asphalts are given in the following Table 4:

TABLE 4

| | | Asphalt product |
|---|---|---|
| | Classic asphalt | according to the |
| Composition | product | invention |
| Granular formula | 32.5% filler, 32% sand, 35.5% 4/6 | |
| Bitumen 35/50 | 8.6 pph | 8.6 pph |
| Hydrogenated castor | — | 0.8 pph |
| oil | | |
| Production | 230° C. | 170° C. |
| temperature | | |
| Indentation at 40° C. | 24 | 11 |
| (1/10 mm) | | |
| Type B | | |
| (specifications *: | | |
| 10 to 30) | | |
| Free shrinkage (%) | 0.205 | 0.075 |

* issue 10 of the administrative and technical specification common to cast asphalts (1999)

The free shrinkage results reveal a clear advantage for asphalt based on hydrogenated oil: lower production temperature, good indentation characteristics, lower free shrinkage.

### EXAMPLE 4

### Bituminous Coated Material BBSG 0/10 at Reduced Temperature

To evaluate the impact of adding a hydrogenated oil on the handling of a coated material the comparative tests has been done. The results are presented in the following Table 5:

TABLE 5

| | | Coated material |
|---|---|---|
| | Classic coated | according to the |
| Composition | material | invention |
| Granular formula | 2% filler, 30% sand, 28% 2/6, 40% 6/10 | |
| Bitumen 35/50 | 5.6 pph | 5.3 pph |
| Hydrogenated castor | — | 0.3 pph |
| oil | | |
| Production | 160° C. | 100° C. |
| temperature | | |
| Test PCG (rotary | 9.1% voids | 7.4% voids |
| shear press, NF EN | | |
| 12697-31) at | | |
| 60 rotations | | |

The bituminous coated material with the binder according to the invention can be produced at 100° C. only. Despite a lower production temperature, the compactibility (% voids) of the coated material containing the additive obtained is just as or even more manageable than the reference coated material.

1. Asphalt or bituminous product comprising a thermofusible binder based on natural asphalt or bitumen, said binder comprising at least one additive, having a melting temperature greater than 60° C., for lowering the production temperature of the asphalt product relative to that of the base product, wherein the additive is at least a fatty acid triglyceride, said fatty acid being itself selected from the group constituted by the saturated fatty acids comprising from 12 to 30 carbon atoms.

2. The asphalt or bituminous product as claimed in claim 1, wherein the fatty acid comprises 12 to 20 carbon atoms.

3. The asphalt or bituminous product as claimed in claim 1, wherein the fatty acid is substituted by a hydroxyl group or by a C₁-C₄ alkyl radical.

4. The asphalt or bituminous product as claimed in claim 1, wherein the fatty acid is selected from the group constituted by 12-hydroxy-octadecanoic acid, hexadecanoic acid, octadecanoic acid, 9,10-dihydroxy-octadecanoic acid, icosanoic acid, nonadecanoic acid, and their mixtures.

5. The asphalt or bituminous product as claimed in claim 1, wherein the additive is at least a triglyceride whereof a fatty acid molecule is constituted by 12-hydroxy-octadecanoic acid.

6. The asphalt or bituminous product as claimed in claim 1, wherein the additive has a melting point greater than 80° C.

7. The asphalt or bituminous product as claimed in claim 1, wherein the additive has a melting point less than 140° C.

8. The asphalt or bituminous product as claimed in claim 1, wherein the additive is a hydrogenated vegetable oil.

9. The asphalt or bituminous product as claimed in claim 8, wherein said vegetable oil is selected form the group constituted by oils of flax, rape seed, sunflower, soya, olive, palm, castor, wood, maize, squash, grape-seed, jojoba, sesame, walnut, hazelnut, almond, shea butter, macadamia, cotton, lucerne, rye, safflower, peanut, copra, argan and their mixtures.

10. The asphalt or bituminous product as claimed in claim 8, wherein the vegetable oil is castor oil.

11. The asphalt or bituminous product as claimed in claim 8, wherein the hydrogenated vegetable oil has an iodine index less than 50 g of I₂/100 g.

12. The asphalt or bituminous product as claimed in claims 8, wherein the hydrogenated vegetable oil has an acid index less than 10 mg KOH/g.

13. The asphalt or bituminous product as claimed in claim 8, wherein the binder contains 1 to 20% in mass of said hydrogenated vegetable oil relative to the total mass of the binder.

14. The asphalt or bituminous product as claimed in claim 1, wherein the binder further comprises one or more additives selected from the group constituted by:
a wax of animal, vegetable or hydrocarbon origin,
a fatty acid derivative selected from the group constituted by fatty acid diesters, fatty acid ethers, amide waxes, diamide waxes and their mixtures,
a natural resin, optionally modified, of vegetable origin, and
a zeolite, natural and/or synthetic, or its amorphous initial synthesis phase.

15. The asphalt or bituminous product as claimed in claim 1, wherein it further comprises a flux agent.

16. The asphalt or bituminous product as claimed in claim 1, wherein the binder further comprises an elastomer or a plastomer.

17. The asphalt or bituminous product as claimed in claim 16, wherein the elastomer or plastomer is selected form the group consisting of a copolymer of styrene-butadiene-styrene, styrene-butadiene, or styrene-isoprene-styrene or ethylene copolymers and their mixtures.

18. A preparation process of a hot-flow asphalt product, comprising mixing a thermofusible binder, with mineral fillers, asphalt aggregates and at least one additive for lowering the production temperature of the asphalt product such as defined in claim 1, in which the mixing temperature is between 140° C. and 180° C.

19. A preparation process of bituminous material, comprising mixing a thermofusible binder, with mineral fillers, aggregate material and at least one additive for lowering the production temperature of the asphalt product such as defined in claim 1, in which the mixing temperature is between 90° C. and 130° C.

20. A hot-flow asphalt product comprising a thermofusible binder such as defined in claim 1 and mineral and/or synthetic fillers, and asphalt aggregates.

21. A bituminous material comprising a thermofusible binder such as defined in claim 1, aggregate material and mineral and/or synthetic fillers.

22. Use of un asphalt product as claimed in claim 20 for making coating for highways, footpaths or other urban facilities, work sealing layers and buildings, sealant, pavement seal and heat sealing product.

23. Use of bituminous material as claimed in claim 21, for making coating for highways, footpaths or other urban facilities, work sealing layers and buildings, sealant, pavement seal and heat sealing product.
